(19) United States
(12) Patent Application Publication
(10) Pub. No.: US 2024/0192433 A1
(43) Pub. Date: Jun. 13, 2024

(54) BACKLIGHT MODULE AND DISPLAY DEVICE

(71) Applicants: Chengdu BOE Optoelectronics Technology Co., Ltd., Chengdu, Sichuan (CN); BOE Technology Group Co., Ltd., Beijing (CN)

(72) Inventors: Xiaolong LIU, Beijing (CN); Xi LI, Beijing (CN); Jingang WANG, Beijing (CN); Yujie WANG, Beijing (CN); Wei ZHANG, Beijing (CN); Pengfei WANG, Beijing (CN)

(21) Appl. No.: 18/282,522

(22) PCT Filed: Oct. 22, 2021
(86) PCT No.: PCT/CN2021/125707

§ 371 Date: Sep. 16, 2023

(30) Foreign Application Priority Data
Mar. 25, 2021 (CN) 202110331176.5

(51) Int. Cl. F21V 8/00

(52) U.S. Cl. CPC G02B 6/0053; G02B 6/0018; G02B 6/0031; G02B 6/009

(57) ABSTRACT

A backlight module and a display device are disclosed. The backlight module includes: a light guide plate, a first bottom surface of the light guide plate being provided with a plurality of dot structures, and the dot structure including a first inclined surface forming a first included angle with the first bottom surface; a backlight source located on a side of a light incident surface, light emitted by the backlight source being incident to the first inclined surface, and an included angle between the emitted light and a horizontal line being a second included angle; and a first prism layer located on the side of a light exiting surface of the light guide plate, the first prism layer having a plurality of first prisms provided in parallel with the light incident surface.

### CROSS REFERENCE TO RELATED APPLICATIONS

The present application is a U.S. National Stage of International Application No. PCT/CN2021/125707, filed on Oct. 22, 2021, which claims priority to Chinese Patent Application No. 202110331176.5, filed with the China National Intellectual Property Administration on Mar. 25, 2021, and entitled “Backlight Module and Display Device”, the entire content of which is incorporated herein by reference.

### TECHNICAL FIELD

The disclosure herein relates to the technical field of backlight modules, and particularly to a backlight module and a display device.

### BACKGROUND

A liquid crystal display (LCD) has many advantages such as thin body, power saving, and no radiation, and thus is widely used in televisions, computers, mobile phones and other electronic products. LCD is a passive light-emitting display, and a display screen of the LCD does not emit light, but is illuminated by a backlight module behind the display screen.

With the change in people's consumption concept, consumers are expecting lighter, thinner and more attractive appearances of LCDs. Traditional backlight modules are divided into two types: a direct type and a side light type, according to different light-emitting methods. A side light module is thinner and more fashionable than a direct type module, which is in line with the fashion pursuit of modern people.

### SUMMARY

An embodiment of the disclosure provides a backlight module, including:
a light guide plate, including a first bottom surface and a light exiting surface which are arranged opposite to each other and a light incident surface connecting the first bottom surface and the light exiting surface, wherein the first bottom surface of the light guide plate is provided with a plurality of dot structures, and the dot structure includes a first inclined surface forming a first included angle with the first bottom surface;
a backlight source, located on a side of the light incident surface, wherein the backlight source is configured to emit light, the light emitted by the backlight source is incident to the first inclined surface, and an included angle between the light emitted by the backlight source and a horizontal line is a second included angle; and
a first prism layer, located on a side of the light exiting surface of the light guide plate, wherein the first prism layer includes a plurality of first prisms arranged in parallel with the light incident surface, the first prism includes: a second bottom surface arranged in parallel with the first bottom surface and a second inclined surface connected with the second bottom surface, and an included angle between the second inclined surface and the second bottom surface is a first vertex angle;
where the first vertex angle is an acute angle, and the first included angle, the second included angle and the first vertex angle satisfy that: the light emitted by the backlight source is incident to the first inclined surface and then reflected to the second inclined surface of the first prism, and a first incident angle between incident light reflected to the second inclined surface of the first prism and a normal of the second inclined surface is a Brewster angle.

Optionally, in the above backlight module according to an embodiment of the disclosure, the first included angle is an acute angle, the second included angle is an acute angle, the first vertex angle is equal to a refraction angle of refracted light formed by the incident light penetrating through the second inclined surface, and the first included angle=the first incident angle−the second included angle/2.

Optionally, in the above backlight module according to an embodiment of the disclosure, only the dot structure located at a center of the light guide plate satisfies that: the first vertex angle is equal to the refraction angle of the refracted light formed by the incident light penetrating through the second inclined surface, the first included angle=the first incident angle−the second included angle/2, and all these dot structures are structurally identical.

Optionally, in the above backlight module according to an embodiment of the disclosure, a sum of the first vertex angle and the first incident angle is 90°.

Optionally, in the above backlight module according to an embodiment of the disclosure, the first prism further includes a third inclined surface connecting the second inclined surface and the second bottom surface, an included angle between the third inclined surface and the second bottom surface is a second vertex angle, and the second vertex angle is equal to the first vertex angle.

Optionally, in the above backlight module according to an embodiment of the disclosure, a density of the dot structures close to the backlight source is smaller than a density of the dot structures away from the backlight source.

Optionally, in the above backlight module according to an embodiment of the disclosure, the density of the dot structures is in an increasing trend in a direction from the backlight source to be away from the backlight source.

Optionally, the above backlight module according to an embodiment of the disclosure further includes a second prism layer located on a side of the first prism layer away from the light guide plate. The second prism layer includes a plurality of second prisms arranged in parallel, the first prisms and the second prisms are alternately arranged, and the first prisms are structurally identical with the second prisms.

Optionally, the above backlight module according to an embodiment of the disclosure further includes a first buffering layer located between the light guide plate and the first prism layer, and a second buffering layer located on a side of the second prism layer facing away from the light guide plate; surfaces of the first buffering layer in contact with the light guide plate and the first prism layer, a surface of the second buffering layer in contact with the second prism layer, and a surface of the second buffering layer facing away from the second prism layer all include protective particles.

Optionally, the above backlight module according to an embodiment of the disclosure further includes a reflection layer located on a side of the first bottom surface of the light guide plate.

Correspondingly, an embodiment of the disclosure further provides a display device, including any above backlight module.

The disclosure has following beneficial effects.

According to the backlight module and the display device provided by embodiments of the disclosure, by arranging the first vertex angle of the first prism, the first included angle formed by the first inclined surface of the dot structure and the first bottom surface of the light guide plate, and the second included angle between the light emitted by the backlight source and the horizontal line, the first included angle, the second included angle and the first vertex angle satisfy that: the light emitted by the backlight source is incident to the first inclined surface and then reflected to the second inclined surface of the first prism, and the first incident angle between the light reflected to the second inclined surface of the first prism and the normal of the second inclined surface is the Brewster angle. In this way, an intensity difference between S light and P light of the light transmitted from the second inclined surface is the maximum, the first prism may have a degree of polarization larger than 0, and compared to a degree of polarization of 0 of a prism in the related art, at least 50% of the light is absorbed by polarized light in general. In embodiments of the disclosure, by matching a light emitting angle of the backlight source, an inclination angle of the first inclined surface of the dot structure and the first vertex angle of the first prism, the first prism may have the degree of polarization larger than 0, so that the light transmitted from the first prism has a higher utilization rate, thus improving light emission efficiency of the backlight module.

### BRIEF DESCRIPTION OF FIGURES

FIG. 1 is a schematic structural diagram of a backlight module according to an embodiment of the disclosure.

FIG. 2 is a schematic diagram of an enlarged part of FIG. 1.

FIG. 3 is a schematic structural diagram of another backlight module according to an embodiment of the disclosure.

FIG. 4 is a schematic structural diagram of a display device according to an embodiment of the disclosure.

### DETAILED DESCRIPTION

In order to make objectives, technical solutions and advantages of the disclosure clearer, the technical solutions of the disclosure will be clearly and completely described below in combination with the accompanying drawings. Apparently, the described embodiments are some embodiments of the disclosure, rather than all embodiments. Without conflict, embodiments in the disclosure and the features in embodiments may be combined with each other. Based on the described embodiments of the disclosure, all other embodiments obtained by those of ordinary skill in the art without creative efforts fall within the protection scope of the disclosure.

Unless otherwise defined, technical or scientific terms used in the disclosure shall have the ordinary meaning as understood by those of ordinary skill in the art to which the disclosure pertains. Similar words such as “comprise” or “include” mean that elements or items appearing before the words encompass elements or items listed after the words and their equivalents, but do not exclude other elements or items. Similar words such as “connection” or “link” are not limited to physical or mechanical connections, but may include electrical connections, whether direct or indirect. “Inner”, “outer”, “upper”, “lower”, etc. are only used to indicate a relative positional relationship, and when an absolute position of a described object changes, the relative positional relationship may also change accordingly.

It should be noted that dimensions and shapes of figures in the accompanying drawings do not reflect a true scale, and are only intended to illustrate contents of the disclosure. The same or similar reference numerals refer to the same or similar elements or elements having the same or similar functions throughout.

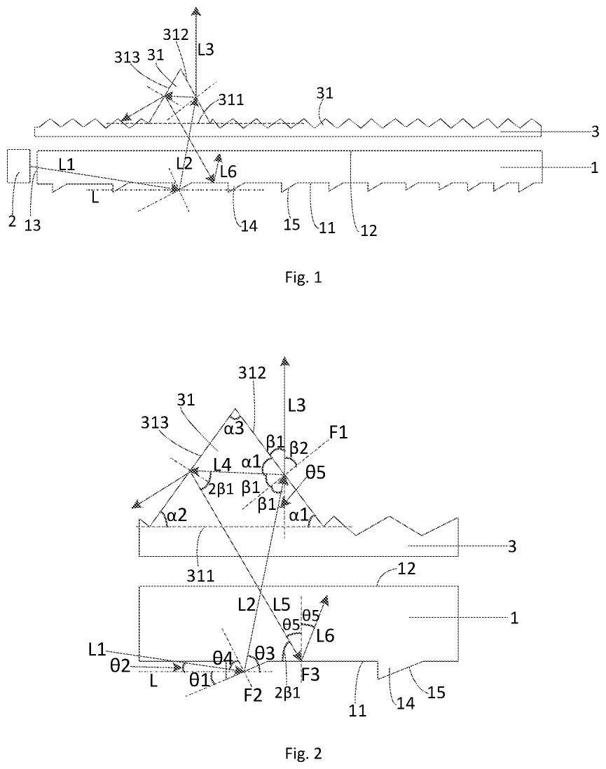

An embodiment of the disclosure provides a backlight module, as shown in FIG. 1 and FIG. 2. FIG. 1 is a schematic sectional diagram of the backlight module, and FIG. 2 is a schematic diagram of an enlarged part of FIG. 1. The backlight module includes:
a light guide plate 1, including a first bottom surface 11 and a light exiting surface 12 which are arranged opposite to each other and a light incident surface 13 connecting the first bottom surface 11 and the light exiting surface 12, where the first bottom surface 11 of the light guide plate 1 is provided with a plurality of dot structures 14, the dot structure 14 includes a first inclined surface 15 forming a first included angle with the first bottom surface 11, and the first included angle and θ1 in FIG. 2 are corresponding angles, so the first included angle is represented by θ1;
a backlight source 2, located on a side of the light incident surface 13, where the backlight source 2 is configured to emit light L1, the light L1 emitted by the backlight source 2 is incident to the first inclined surface 15, and an included angle between the light L1 emitted by the backlight source 2 and a horizontal line L is a second included angle θ2; and
a first prism layer 3, located on a side of the light exiting surface 12 of the light guide plate 1, where the first prism layer 3 includes a plurality of first prisms 31 arranged in parallel with the light incident surface 13, the first prism 31 includes: a second bottom surface 311 arranged in parallel with the first bottom surface 11 and a second inclined surface 312 connected with the second bottom surface 311, and an included angle between the second inclined surface 312 and the second bottom surface 311 is a first vertex angle α1;
where the first vertex angle α1 is an acute angle, and the first included angle θ1, the second included angle θ2 and the first vertex angle α1 satisfy that: the light L1 emitted by the backlight source 2 is incident to the first inclined surface 15 and then reflected to the second inclined surface 312 of the first prism 31, and a first incident angle β1 between incident light L2 reflected to the second inclined surface 312 of the first prism 31 and a normal F1 of the second inclined surface 312 is a Brewster angle.

It should be noted that, all first prisms 31 in FIG. 1 are structurally identical, the first prism 31 with a plurality of arrows in FIG. 1 is a structure enlarged for the purpose of illustrating different beams of light, and FIG. 2 is a schematic diagram enlarged for the purpose of clearly illustrating different beams of light and angles.

A beam of natural light may be decomposed into S light and P light by a reflecting interface, where the S light vibrates vertically at the interface and the P light vibrates in parallel at the interface; and due to different incident angles and a difference in interface refractive indexes, the S light and the P light will have different degrees of reflectivity and refractive indexes. As shown in FIG. 1 and FIG. 2, after the incident light L2 is incident to the second inclined surface 312, an included angle between the refracted light L3 and the normal F1 is a refraction angle β2; when the first incident angle β1 is the Brewster angle, β1+β2=90°. That is, when the first incident angle β1 and the refraction angle β2 are complementary angles of each other, reflected light L4 does not have a P component, the reflected light L4 is parallel to the horizontal line L, and at the moment, a maximum difference exists between reflectivity Rs of the S light and reflectivity Rp of the P light, and Rp=0. According to the law of refraction formula n1 sin β1=n2 sin β2, where n1 is a refractive index of the first prism layer 3, and n2 is a refractive index of air. For example, the refractive index of the first prism layer 3 is 1.38, the refractive index of the air is 1, and it can be calculated through the formula n1 sin β1=n2 sin β2 and the formula β1+β2=90° that β1 is about 36° and β2=54°. For the backlight module of an embodiment of the disclosure, the light L1 starts from the backlight source 2, passes through the light guide plate 1, and is upwardly emitted through the first prism layer 3 (refracted light L3). For the first prism layer, the refracted light L3 is transmitted light, so an embodiment of the disclosure analyzes a degree of polarization of transmitted light (refracted light L3). Ts and Tp may be calculated through Fresnel's Formula

$$R s = \frac{{sin}^{2} ( β 1 - β 2 )}{{sin}^{2} ( β 1 + β 2 ) )} , Rp = \frac{{tan}^{2} ( β 1 - β 2 )}{{tan}^{2} ( β 1 + β 2 )} ,$$

and Ts+Rs=1=Tp+Rp, and then the degree of polarization Pt of the refracted light L3 may be calculated according to a degree of polarization Pt formula of transmitted light:

$$P t = \vert \frac{Tp - Ts}{Tp + Ts} \vert .$$

In an embodiment of the disclosure, the degree of polarization Pt of the refracted light L3 is calculated to be about 5%, indicating that the degree of polarization of the transmitted light is increased from 0% to 5%, and this part of light may be utilized, so a utilization rate of the light emitted by the backlight module may be increased and power consumption thereof is reduced.

According to the above backlight module provided by an embodiment of the disclosure, by arranging the first vertex angle of the first prism, the first included angle formed by the first inclined surface of the dot structure and the first bottom surface of the light guide plate, and the second included angle between the light emitted by the backlight source and the horizontal line, the first included angle, the second included angle and the first vertex angle satisfy that: the light emitted by the backlight source is incident to the first inclined surface and then reflected to the second inclined surface of the first prism, and the first incident angle between the light reflected to the second inclined surface of the first prism and the normal of the second inclined surface is a Brewster angle. In this way, an intensity difference between S light and P light of the light transmitted from the second inclined surface is the maximum, the first prism may have a degree of polarization larger than 0, and compared to a degree of polarization of 0 of a prism in the related art, at least 50% of the light is absorbed by polarized light in general. In an embodiment of the disclosure, by matching a light emitting angle of the backlight source, an inclination angle of the first inclined surface of the dot structure and the first vertex angle of the first prism, the first prism may have the degree of polarization larger than 0, so that the light transmitted from the first prism has a higher utilization rate, thus improving light emission efficiency of the backlight module.

In specific implementation, the dot structures of the light guide plate may be formed by an injection process, which is not limited here.

In an embodiment of the disclosure, by matching the first included angle θ1, the second included angle θ2 and the first vertex angle α1, the first incident angle β1 is the Brewster angle, and the first prism layer has the degree of polarization larger than 0, thus improving the light emission efficiency of the backlight module. As shown in FIG. 1 and FIG. 2, the reflected light L4 is parallel to the horizontal line L, an included angle between the reflected light L4 and the second inclined surface 312 is equal to α1, and a reflection angle of the incident light L2 is β1, so α1+β1=90°, and because β1+β2=90°, α1=β2. Because the incident light L2 relative to the light L1 is the refracted light of the first inclined surface 15, and an included angle between the incident light L2 and the light L is θ3, an included angle θ4 between the light L1 and a normal F2 of the first inclined surface 15 satisfies that: 2θ4=180°−θ2−θ3; an included angle between the incident light L2 and a reverse extending line of the refracted light L3 is θ5, and because the light L4 is perpendicular to the reverse extending line of the refracted light L3, θ5=90°−2β1; and θ3=90°−θ5=90°−(90°−2β1)=2β1, so 2θ4=180°−θ2−2β1, so θ4=90°−θ2/2−β1, so θ1=90°−θ2−θ4=90°−θ2−(90°−θ2/2−β1)=β1−θ2/2. Therefore, in the above backlight module provided by an embodiment of the disclosure, when the first included angle θ1 is an acute angle, the second included angle θ2 is an acute angle, the first vertex angle (α1) is equal to the refraction angle (θ2) of the refracted light L3 formed by the incident light L2 penetrating through the second inclined surface 312, and the first included angle (θ1)=the first incident angle (β1)−the second included angle (θ2)/2, it may be realized that the first incident angle β1 when the light L1 emitted by the backlight source 2 is incident to the first inclined surface 15 and then reflected to the second inclined surface 312 is the Brewster angle; and it may be realized that the first prism layer has the degree of polarization larger than 0, so that the utilization rate of the light transmitted by the first prism is higher, and therefore the light emission efficiency of the backlight module is improved.

In specific implementation, as shown in FIG. 1 and FIG. 2, because the light L1 emitted by the backlight source 2 is incident to different locations of the light guide plate 1, included angles between different pieces of emitted light L1 and the horizontal line L are different; and if the first incident angle β1 when the light L1 emitted by the backlight source 2 is incident to the first inclined surface 15 and reflected to the second inclined surface 312 is the Brewster angle, the included angle between the first inclined surface 15 of the dot structure 14 of each first prism 31 and the horizontal line L needs to be designed, so mass production may be difficult to realize due to high manufacturing costs. Therefore, the dot structure 14 at a center of the light guide plate 1 may be designed to satisfy the above conditions for the Brewster angle, and a light emission rate of the backlight module may be improved. Therefore, in the above backlight module provided by an embodiment of the disclosure, only the dot structure 14 located at the center of the light guide plate 1 satisfies that: the first vertex angle (α1) is equal to the refraction angle (β2) of the refracted light L3 formed by the incident light L2 penetrating through the second inclined surface 312, the first included angle (θ1)=the first incident angle (β1)−the second included angle (θ2)/2, and all these dot structures 14 are structurally identical.

It should be noted that, the structure of the light guide plate 1 in FIG. 1 is described merely for an illustrative purpose, which does not indicate that the third dot structure 14 from the left satisfies the conditions for the Brewster angle. In practical manufacturing, the dot structure 14 at the center of the light guide plate 1 satisfies the conditions for the Brewster angle.

In specific implementation, as shown in FIG. 1 and FIG. 2, in order to further improve the light emission rate of the backlight module, the refracted light L3 needs to be vertically emitted as much as possible. That is, the refracted light L3 and the reflected light L4 are perpendicular. Because the included angle between the reflected light L4 and the second inclined surface 312 is equal to α1, the included angle between the refracted light L3 and the second inclined surface 312 is equal to β1. Therefore, in the above backlight module provided by an embodiment of the disclosure, a sum of the first vertex angle α1 and the first incident angle β1 is 90°, so the light emission rate of the backlight module may further be improved.

In specific implementation, in the above backlight module provided by an embodiment of the disclosure, as shown in FIG. 1 and FIG. 2, the first prism 31 further includes a third inclined surface 313 connecting the second inclined surface 312 and the second bottom surface 311, and an included angle between the third inclined surface 313 and the second bottom surface 311 is a second vertex angle α2. Because the reflected light L4 is further reflected and refracted after being incident to the third inclined surface 313, and for example, forms reflected light L5, and the reflected light L5 will be further reflected (reflected light L6) after being incident to the light guide plate 1, in order to improve the light emission rate of the backlight module by repeated utilization of the reflected light L5, the reflected light L6 needs to be parallel to the incident light L2, so that an incident angle of the reflected light L6 incident to the second inclined surface 312 of the first prism 31 is the Brewster angle, thus improving the light emission rate of the backlight module. If the reflected light L6 is parallel to the incident light L2, an included angle between the reflected light L6 and the normal F3 is θ5, and an incident angle of the reflected light L5 incident to the light guide plate 1 is θ5; because θ5=90°−2β1, an included angle between the reflected light L4 and the reflected light L5 is 2β1, that is, the incident angle of the reflected light L4 is β1, so the second vertex angle α2=90°−β1; and because α1=90°−β1, the second vertex angle α2 is equal to the first vertex angle α1, that is, when α2=α1, the reflected light L6 is parallel to the incident light L2, which may realize that the reflected light L5 can be repeatedly utilized to improve the light emission rate of the backlight module.

It is calculated above that α1=β2=54°, so α2=54°, and therefore the third vertex angle α3 of the first prism 31 is equal to 72°. β1=90°−β2=36°, and then θ5=90°−2β1=18°. Assuming that the second included angle θ2 between the light L1 emitted by the backlight source 2 and the horizontal line L is equal to 2°, all θ1=β1−(θ2)/2=35°, so θ4=90°−θ1−θ2=53°. Assuming that the light guide plate 1 adopts a PC material and a refractive index of the light guide plate 1 is 1.89, it may be calculated that a total reflection angle of the light guide plate 1 is about 39°. Therefore, θ4 is larger than the total reflection angle of the light guide plate 1, transmission does not exit, and conditions for total reflection are satisfied.

It should be noted that, the angle values calculated above are obtained based on a refractive index of the first prism layer being 1.38. In specific implementation, the angles in FIG. 2 are related to the refractive index of the first prism layer, so specific degrees of the angles are calculated by substituting the refractive index of the first prism layer into the above formulas.

In specific implementation, because a part of the light guide plate close to the backlight source receives stronger light emitted by the backlight source, in order to realize even light emission of the backlight module, in the above backlight module provided by an embodiment of the disclosure, as shown in FIG. 1, a density of the dot structures 14 close to the backlight source 2 is smaller than a density of the dot structures 14 away from the backlight source 2.

Optionally, in the above backlight module provided by an embodiment of the disclosure, as shown in FIG. 1, the density of the dot structures 14 is in an increasing trend in a direction from the backlight source 2 to be away from the backlight source 2.

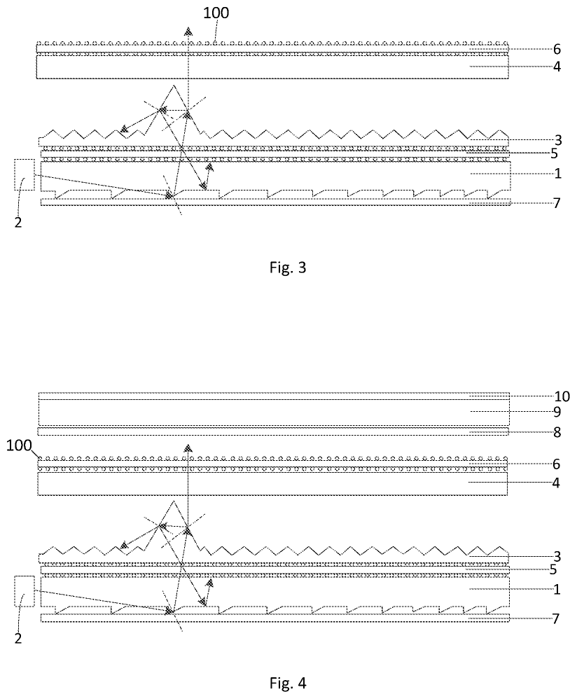

In specific implementation, the above backlight module provided by an embodiment of the disclosure, as shown in FIG. 3, further includes a second prism layer 4 located on a side of the first prism layer 3 away from the light guide plate 1. The second prism layer 4 includes a plurality of second prisms (not shown) arranged in parallel, the first prisms 31 and the second prisms are alternately arranged, and the first prisms 31 are structurally identical with the second prisms.

In specific implementation, the above backlight module provided by an embodiment of the disclosure, as shown in FIG. 3, further includes a first buffering layer 5 located between the light guide plate 1 and the first prism layer 3, and a second buffering layer 6 located on a side of the second prism layer 4 facing away from the light guide plate 1. Surfaces of the first buffering layer 5 in contact with the light guide plate 1 and the first prism layer 3, a surface of the second buffering layer 6 in contact with the second prism layer 4, and a surface of the second buffering layer 6 facing away from the second prism layer 4 all include protective particles 100. Through the arrangement of the protective particles 100, on the one hand, the dot structures 14 of the light guide plate 1 may be shielded, and film layers may further be prevented from being scratched; and on the other hand, an absorption phenomenon may be avoided between the first prism layer 3 and the light guide plate 1 and between the second prism layer 4 and the first prism layer 3. Adsorption will cause the film layers to be immersed in water stains, so that the light no longer comes out according to the exit law of the prisms, resulting in a decrease in brightness in a positive viewing angle; and by changing roughness of a lower surface of the upper film layer (such as being coated with the protective particles 100), the adsorption phenomenon can be relieved.

It should be noted that the circular protective particles 100 in FIG. 3 are merely an example illustrating that the surfaces of the first buffering layer 5 and the second buffering layer 6 have the protective parties 100, but do not represent the actual shape of the protective parties. The protective particles 100 may be in other shapes as well.

In specific implementation, in order to further improve the utilization rate of the light emitted by the backlight source, the above backlight module provided by an embodiment of the disclosure, as shown in FIG. 3, may further include a reflection layer 7 located on a side of the first bottom surface 11 of the light guide plate 1.

It should be noted that, as shown in FIG. 1 to FIG. 3, the film layers of the backlight module are in contact with one another in practical manufacturing. An embodiment of the disclosure merely illustrates the structure of the film layers.

Based on the same inventive concept, an embodiment of the disclosure further provides a display device, including the above backlight module provided by an embodiment of the disclosure. The display device may be: a mobile phone, a tablet computer, a television, a monitor, a laptop, a digital photo frame, a navigator and any other product or component with a display function. For implementation of the display device, reference may be made to the above embodiment of the backlight module, and repeated description will not be made here.

In specific implementation, the above display device provided by an embodiment of the disclosure, as shown in FIG. 4, further includes a first polarizer 8 located on a light exiting side of a backlight module shown in FIG. 3, a liquid crystal display panel 9 and a second polarizer 10. Working principles of the first polarizer 8, the liquid crystal display panel 9 and the second polarizer 10 are the same as the related art, and will not be repeated here.

According to the backlight module and the display device provided by embodiments of the disclosure, by arranging the first vertex angle of the first prism, the first included angle formed by the first inclined surface of the dot structure and the first bottom surface of the light guide plate, and the second included angle between the light emitted by the backlight source and the horizontal line, the first included angle, the second included angle and the first vertex angle satisfy that: the light emitted by the backlight source is incident to the first inclined surface and then reflected to the second inclined surface of the first prism, and the first incident angle between the light reflected to the second inclined surface of the first prism and the normal of the second inclined surface is the Brewster angle. In this way, the intensity difference between the S light and the P light of the light transmitted from the second inclined is the maximum, the first prism may have the degree of polarization larger than 0, and compared to the degree of polarization of 0 of a prism in the related art, at least 50% of the light is absorbed by polarized light in general. In an embodiment of the disclosure, by matching the light emitting angle of the backlight source, the inclination angle of the first inclined surface of the dot structure and the first vertex angle of the first prism, the first prism may have the degree of polarization larger than 0, so that more light may be utilized, thus improving the light emission efficiency of the backlight module.

Although embodiments of the disclosure have been described, those of skill in the art may otherwise make various modifications and variations to these embodiments once they are aware of the basic inventive concept. Therefore, the claims intend to include embodiments as well as all these modifications and variations falling within the scope of the disclosure.

Obviously, those skilled in the art can make various changes and modifications to embodiments of the disclosure without departing from the spirit and scope of embodiments of the disclosure. Thus, if these modifications and variations of embodiments of the disclosure fall within the scope of the claims of the present disclosure and their equivalents, the present disclosure is also intended to include these modifications and variations.

1. A backlight module, comprising:
a light guide plate, comprising a first bottom surface and a light exiting surface which are arranged opposite to each other and a light incident surface connecting the first bottom surface and the light exiting surface, wherein the first bottom surface of the light guide plate is provided with a plurality of dot structures, and the dot structure comprises a first inclined surface forming a first included angle with the first bottom surface;
a backlight source, located on a side of the light incident surface, wherein the backlight source is configured to emit light, the light emitted by the backlight source is incident to the first inclined surface, and an included angle between the light emitted by the backlight source and a horizontal line is a second included angle; and
a first prism layer, located on a side of the light exiting surface of the light guide plate, wherein the first prism layer comprises a plurality of first prisms arranged in parallel with the light incident surface, the first prism comprises: a second bottom surface arranged in parallel with the first bottom surface and a second inclined surface connected with the second bottom surface, and an included angle between the second inclined surface and the second bottom surface is a first vertex angle; wherein
the first vertex angle is an acute angle, and the first included angle, the second included angle and the first vertex angle satisfy that: the light emitted by the backlight source is incident to the first inclined surface and then reflected to the second inclined surface of the first prism, and a first incident angle between incident light reflected to the second inclined surface of the first prism and a normal of the second inclined surface is a Brewster angle.

2. The backlight module according to claim 1, wherein the first included angle is an acute angle, the second included angle is an acute angle, the first vertex angle is equal to a refraction angle of refracted light formed by the incident light penetrating through the second inclined surface, and the first included angle=the first incident angle−the second included angle/2.

3. The backlight module according to claim 2, wherein only the dot structure located at a center of the light guide plate satisfies that: the first vertex angle is equal to the refraction angle of the refracted light formed by the incident light penetrating through the second inclined surface, the first included angle=the first incident angle−the second included angle/2, and all the dot structures are structurally identical.

4. The backlight module according to claim 1, wherein a sum of the first vertex angle and the first incident angle is 90°.

5. The backlight module according to claim 4, wherein the first prism further comprises a third inclined surface connecting the second inclined surface and the second bottom surface, an included angle between the third inclined surface and the second bottom surface is a second vertex angle, and the second vertex angle is equal to the first vertex angle.

6. The backlight module according to claim 1, wherein a density of the dot structures close to the backlight source is smaller than a density of the dot structures away from the backlight source.

7. The backlight module according to claim 6, wherein the density of the dot structures is in an increasing trend in a direction from the backlight source to be away from the backlight source.

8. The backlight module according to claim 1, further comprising a second prism layer located on a side of the first prism layer away from the light guide plate, wherein the second prism layer comprises a plurality of second prisms arranged in parallel, the first prisms and the second prisms are alternately arranged, and the first prisms are structurally identical with the second prisms.

9. The backlight module according to claim 8, further comprising: a first buffering layer located between the light guide plate and the first prism layer, and a second buffering layer located on a side of the second prism layer facing away from the light guide plate; wherein surfaces of the first buffering layer in contact with the light guide plate and the first prism layer, a surface of the second buffering layer in contact with the second prism layer, and a surface of the second buffering layer facing away from the second prism layer all comprise protective particles.

10. The backlight module according to claim 8, further comprising a reflection layer located on a side of the first bottom surface of the light guide plate.

11. A display device, comprising a backlight module, the backlight module comprising:
a light guide plate, comprising a first bottom surface and a light exiting surface which are arranged opposite to each other and a light incident surface connecting the first bottom surface and the light exiting surface, wherein the first bottom surface of the light guide plate is provided with a plurality of dot structures, and the dot structure comprises a first inclined surface forming a first included angle with the first bottom surface;
a backlight source, located on a side of the light incident surface, wherein the backlight source is configured to emit light, the light emitted by the backlight source is incident to the first inclined surface, and an included angle between the light emitted by the backlight source and a horizontal line is a second included angle; and
a first prism layer, located on a side of the light exiting surface of the light guide plate, wherein the first prism layer comprises a plurality of first prisms arranged in parallel with the light incident surface, the first prism comprises: a second bottom surface arranged in parallel with the first bottom surface and a second inclined surface connected with the second bottom surface, and an included angle between the second inclined surface and the second bottom surface is a first vertex angle; wherein
the first vertex angle is an acute angle, and the first included angle, the second included angle and the first vertex angle satisfy that: the light emitted by the backlight source is incident to the first inclined surface and then reflected to the second inclined surface of the first prism, and a first incident angle between incident light reflected to the second inclined surface of the first prism and a normal of the second inclined surface is a Brewster angle.

12. The display device module according to claim 11, wherein the first included angle is an acute angle, the second included angle is an acute angle, the first vertex angle is equal to a refraction angle of refracted light formed by the incident light penetrating through the second inclined surface, and the first included angle=the first incident angle−the second included angle/2.

13. The display device according to claim 12, wherein only the dot structure located at a center of the light guide plate satisfies that: the first vertex angle is equal to the refraction angle of the refracted light formed by the incident light penetrating through the second inclined surface, the first included angle=the first incident angle−the second included angle/2, and all the dot structures are structurally identical.

14. The display device according to claim 11, wherein a sum of the first vertex angle and the first incident angle is 90°.

15. The display device according to claim 14, wherein the first prism further comprises a third inclined surface connecting the second inclined surface and the second bottom surface, an included angle between the third inclined surface and the second bottom surface is a second vertex angle, and the second vertex angle is equal to the first vertex angle.

16. The display device according to claim 11, wherein a density of the dot structures close to the backlight source is smaller than a density of the dot structures away from the backlight source.

17. The display device according to claim 16, wherein the density of the dot structures is in an increasing trend in a direction from the backlight source to be away from the backlight source.

18. The display device according to claim 11, further comprising a second prism layer located on a side of the first prism layer away from the light guide plate, wherein the second prism layer comprises a plurality of second prisms arranged in parallel, the first prisms and the second prisms are alternately arranged, and the first prisms are structurally identical with the second prisms.

19. The display device according to claim 18, further comprising: a first buffering layer located between the light guide plate and the first prism layer, and a second buffering layer located on a side of the second prism layer facing away from the light guide plate; wherein surfaces of the first buffering layer in contact with the light guide plate and the first prism layer, a surface of the second buffering layer in contact with the second prism layer, and a surface of the second buffering layer facing away from the second prism layer all comprise protective particles.

20. The display device according to claim 18, further comprising a reflection layer located on a side of the first bottom surface of the light guide plate.
